(19) United States
(12) Patent Application Publication
(10) Pub. No.: US 2020/0049123 A1
(43) Pub. Date: Feb. 13, 2020

(54) VORTEX HYDROTURBINE AND METHOD FOR OPERATING THE VORTEX HYDROTURBINE

(71) Applicant: PETER C. WHITTINGTON, OAKLAND PARK, FL (US)

(72) Inventor: PETER C. WHITTINGTON, OAKLAND PARK, FL (US)

(21) Appl. No.: 16/655,543

(22) Filed: Oct. 17, 2019

Related U.S. Application Data
(63) Continuation-in-part of application No. 15/965,238, filed on Apr. 27, 2018.

(51) Int. Cl. F03B 13/06; B04C 9/00

(52) U.S. Cl. CPC F03B 13/06; F05B 2220/706; B04C 2009/007; B04C 9/00

(57) ABSTRACT

A vortex hydroturbine includes a tank to be filled with a liquid, such as water. At least one turbine is driven exclusively by flowing water to circulate the liquid within the tank and produce a vortex. A central turbine is driven by the circulating liquid and an electric generator is driven by the central turbine for producing electricity to be supplied to a load. A method for operating a vortex hydroturbine is also provided.

### CROSS-REFERENCE TO RELATED APPLICATION

This application is a Continuation-In-Part of U.S. application Ser. No. 15/965,238, filed Apr. 27, 2018; the prior application is herewith incorporated by reference in its entirety.

### BACKGROUND OF THE INVENTION

### Field of the Invention

The present invention relates to an apparatus, in the form of a vortex hydroturbine, for generating electricity. The invention also relates to a method for operating the vortex hydroturbine.

### Description of the Related Art

When natural disasters such as hurricanes occur, overhead electric lines are almost always affected since they are exposed to the environment. However, water lines which generally run underground are not affected since they are sheltered from the environment. Other sources of running water, such as rivers and streams and water running down from reservoirs or lakes also continue to flow. Water may also be pumped from trucks or ships sent into a disaster area.

Such sources of hydroelectricity are known as run-of-the-river hydroelectric stations which use only the water coming from upstream for power generation. Hydroelectric facilities are classified as large, small, micro and pico, depending on the amount of power that is generated. For instance, a micro hydroelectric facility usually produces up to 100 KW of power which is sufficient for a home or a small community and a pico hydroelectric facility usually produce less than 5 KW of power which is sufficient for a one or two fluorescent light bulbs, a TV or radio and for charging cell phones for a few homes. A pico hydroelectric facility is usually a run-of-the-river facility, so that dams are not used but instead pipes divert some of the flow, drop it down a gradient of only 1 m (3 ft) and guide it through a turbine before returning it to the stream or other source of running water.

U.S. Pat. No. 9,856,850 discloses a system for generating electricity and for operating machines in which water is aerated and forced to flow upward in flow chambers to produce a hydrostatic head. The aerated water drives a rotating mechanism above a storage tank which in turn rotates a shaft to generate electricity or perform other work. The system avoids the necessity of placing a hydroelectric generator near a river or stream by using a source of gas to aerate the water and force it upward. Therefore, such a system cannot be used where a pressurized gas source is not present.

### BRIEF SUMMARY OF THE INVENTION

It is accordingly an object of the invention to provide a vortex hydroturbine and a method for operating the vortex hydroturbine, which overcome the hereinafore-mentioned disadvantages of the heretofore-known turbines and methods of this general type and which provide electricity where only running water is available.

With the foregoing and other objects in view there is provided, in accordance with the invention, a vortex hydroturbine, comprising a tank to be filled with a liquid, at least one turbine driven exclusively by flowing water received directly from a source outside of the vortex hydroturbine for circulating the liquid within the tank, a central turbine to be driven by the circulating liquid, and an electric generator to be driven by the central turbine for producing electricity.

With the objects of the invention in view, there is also provided a method for operating a vortex hydroturbine, which comprises filling a tank with a liquid, exclusively using flowing water received directly from a source outside of the vortex hydroturbine to drive at least one turbine to circulate the liquid within the tank, using the circulating liquid to drive a central turbine, and using the central turbine to drive an electric generator for producing electricity.

The invention has the advantage of producing electric power only by using existing flowing or falling water received directly from a source outside of the vortex hydroturbine. The amount of electric power is dependent on the force of the flowing or falling water.

The at least one turbine may be a plurality of primary turbines creating a vortex in the liquid in the tank. The nature and the density of the liquid, and especially the vortex created in the liquid, creates a great amount of inertia which tends to keep the central turbine rotating.

In accordance with another feature of the invention, the at least one turbine is a plurality of primary turbines, a plurality of shafts are each connected to a respective one of the primary turbines, and a plurality of secondary turbines are each connected to a respective one of the shafts and exposed to the flowing water to turn the plurality of secondary turbines.

In accordance with a further feature of the invention, at least one flow guide is associated with the at least one turbine for directing the circulating liquid in a circumferential direction of the tank and creating a vortex in the liquid in the tank.

In accordance with an added feature of the invention, the flowing water is supplied from at least one of a river, a stream, a lake, a reservoir, a vehicle or a municipal water supply.

In accordance with an additional feature of the invention, an inlet pipe is used for feeding water as the liquid to the tank.

In accordance with yet another feature of the invention, a shaft interconnects the central turbine and the electric generator.

In accordance with yet a further feature of the invention, a capacitor is charged by the electricity produced by the electric generator.

In accordance with yet an added feature of the invention, a cabinet is provided on which the tank stands, and the electric generator is disposed within the cabinet.

In accordance with yet an additional feature of the invention, a collar is disposed between the cabinet and the tank, and the secondary turbines are disposed within the collar.

In accordance with again another feature of the invention, a ladder is disposed adjacent the cabinet for providing access to said tank.

In accordance with a concomitant feature of the invention, the tank is frustoconical, the tank has a bottom and a top having a larger diameter than the bottom, and the central turbine is disposed on the bottom.

Other features which are considered as characteristic for the invention are set forth in the appended claims.

Although the invention is illustrated and described herein as embodied in a vortex hydroturbine and a method for operating the vortex hydroturbine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, perspective view of the vortex hydroturbine according to the invention; and

FIG. 2 is a longitudinal-section view of the vortex hydroturbine; and

FIG. 3 is a cross-sectional view of the vortex hydroturbine.

### DETAILED DESCRIPTION OF THE INVENTION

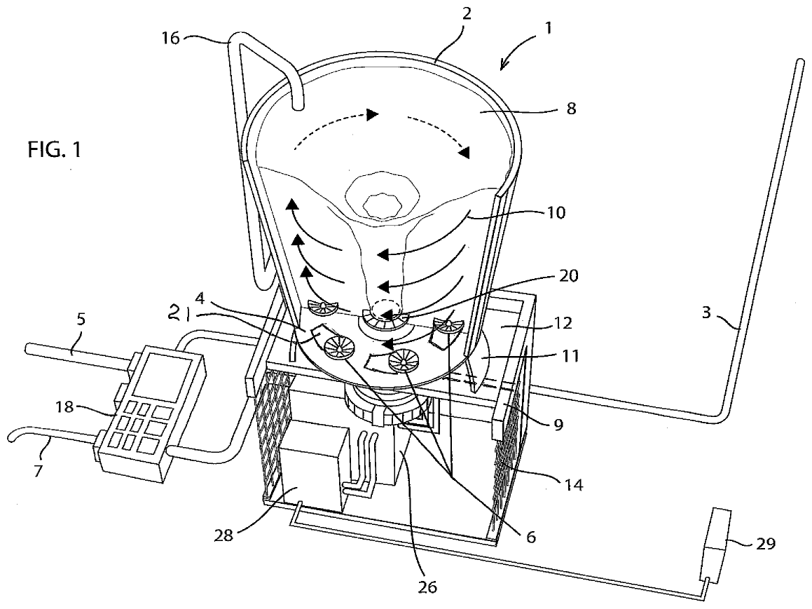

Referring now to the figures of the drawings in detail and first, particularly to FIG. 1 thereof, there is a tank 1 having a frustoconical shape in which the wider end of the frustrum of the cone is at the top. The tank has an open top 2 and a closed bottom 4, although the top may be closed by a non-illustrated cover to prevent evaporation. The bottom 4 of the tank 1 rests on the upper surface 9 of a collar 11, which in turn rests within a recess 12 in the upper surface of a machine cabinet 14.

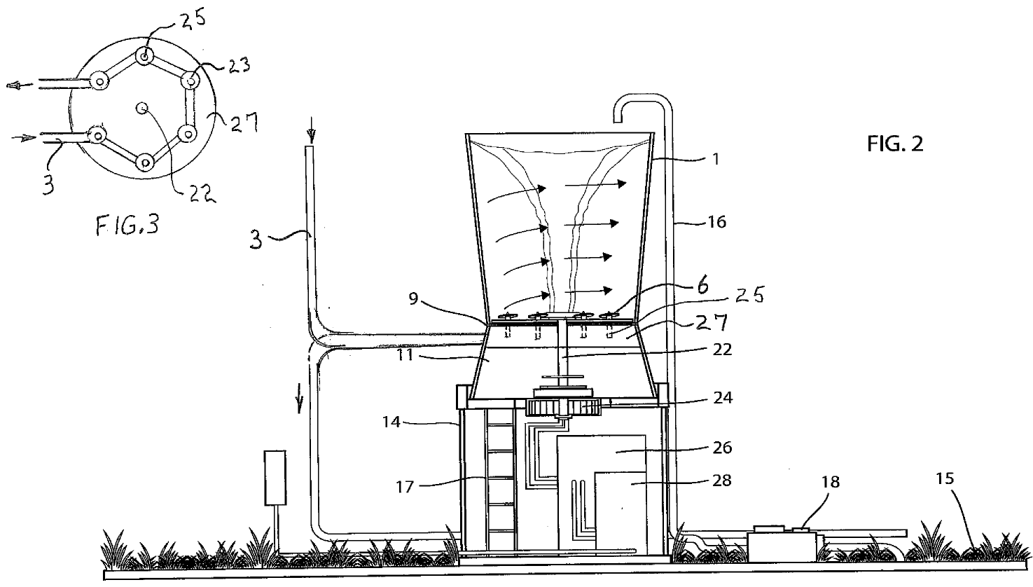

A plurality of primary vortex turbines or fans 6 is located on the bottom 4 of the tank 1. Each primary turbine 6 is associated with a flow guide 21. The tank 1 is filled with a liquid 8 which is set in a circular motion indicated by arrows 10 by the force of the turbines 6 and the guidance of the flow guides 21 creating a vortex in the liquid. The liquid 8 may be water or another liquid, such as oil or antifreeze and may be fed into the tank by a pipe 16. The liquid or water for filling the tank may be fed through the inlet pipe 16 by gravity or optionally by a pump 18. The frustoconical shape of the tank and the angled orientation of the primary turbines 6 shown in FIG. 2 facilitate the development of the vortex.

As is seen in FIG. 3, the primary turbines 6 are each connected to a shaft 25 which is in turn connected to a secondary turbine 23 disposed within a manifold or chamber 27. Only a portion of the shafts 25 are shown in FIG. 2 for the sake of clarity. The secondary turbine 23 may be a disk such as a runner of a water turbine or a water wheel having blades pushed by the flowing water. Water is fed through a pipe 3 into the manifold or chamber 27 where it is fed to and drives each of the secondary turbines 23, thus driving the shafts 25 and the primary turbines 6. The water may be derived from one or more of several possible sources. A first source of water flowing in the pipe 3 comes directly from a river, a stream, a lake, a reservoir, a roof or a cistern. A second source of water is from water trucks brought near the tank and pumped or fed by gravity through a pipe 5 into the pipe 3. A third source is water in a pipe 7 from a municipal water supply which is fed into the pipe 3. The connections of the pipes 5 and 7 to the pipe 3 pass through valves within the cabinet 14. The pipe 3 carries the water out of the manifold or chamber 27 after turning the last secondary turbine 23 and may return the water to its source or to another location, such as for irrigation, washing or to be filtered for human consumption.

A ladder 17 (seen in FIG. 2) permits access to the tank. If the tank is made smaller in size for producing electric power from a less powerful source of flowing water, the ladder may be dispensed with.

The circular motion 10 of the liquid or water 8 in the tank 1 turns a central turbine 20 within the tank 1. The central turbine 20 is connected though a shaft 22, which passes through the collar 11, to a generator 24 located in the cabinet 14 that stands on the ground 15, as is best seen in FIG. 2. The generator 24 produces electrical energy which may be stored in a capacitor 26 if the supply of electrical energy exceeds the demand at any given time. The capacitor 26 may be connected directly to a load or consumers or through a generator crossover or transfer switch 28 and through a panel box 29 to the electrical mains or city or municipal power line for providing electrical power to the load or consumers. The load or consumers may be residential or commercial facilities or municipal facilities such as lighting for streets and parks.

As mentioned above, the water in the pipe 3 only needs to fall a minimum of 1 meter (3 feet) to supply 5 KW of power. If the water comes from a higher level or, for instance from a dam, or if it is pumped from a ship, a truck or a water plant, it can produce significantly more power up to approximately 100 KW.

1. A vortex hydroturbine, comprising:
a tank to be filled with a liquid;
at least one turbine driven exclusively by flowing water received directly from a source outside of the vortex hydroturbine for circulating the liquid within said tank;
a central turbine to be driven by the circulating liquid; and
an electric generator to be driven by said central turbine for producing electricity.

2. The vortex hydroturbine according to claim 1, wherein said at least one turbine is a plurality of primary turbines, a plurality of shafts are each connected to a respective one of said primary turbines, and a plurality of secondary turbines are each connected to a respective one of said shafts and exposed to the flowing water to turn said plurality of secondary turbines.

3. The vortex hydroturbine according to claim 1, which further comprises at least one flow guide associated with said at least one turbine for directing the circulating liquid in a circumferential direction of said tank and creating a vortex in the liquid in said tank.

4. The vortex hydroturbine according to claim 2, wherein the flowing water is supplied from at least one of a river, a stream, a lake, a reservoir, a vehicle or a municipal water supply through a pipe sequentially to each of said secondary turbines.

5. The vortex hydroturbine according to claim 2, which further comprises an inlet pipe for feeding water as the liquid to said tank.

6. The vortex hydroturbine according to claim 1, which further comprises a shaft interconnecting said central turbine and said electric generator.

7. The vortex hydroturbine according to claim 1, which further comprises a capacitor to be charged by the electricity produced by said electric generator.

8. The vortex hydroturbine according to claim 2, which further comprises a cabinet on which said tank stands, said electric generator being disposed within said cabinet.

9. The vortex hydroturbine according to claim 8, which further comprises a collar disposed between said cabinet and said tank, said secondary turbines being disposed within said collar.

10. The vortex hydroturbine according to claim 9, which further comprises a ladder disposed adjacent said cabinet for providing access to said tank.

11. The vortex hydroturbine according to claim 1, wherein said tank is frustoconical, said tank has a bottom and a top having a larger diameter than said bottom, and said central turbine is disposed on said bottom.

12. A method for operating a vortex hydroturbine, the method comprising the following steps:
filling a tank with a liquid;
exclusively using flowing water received directly from a source outside of the vortex hydroturbine to drive at least one turbine to circulate the liquid within the tank;
using the circulating liquid to drive a central turbine; and
using the central turbine to drive an electric generator for producing electricity.

13. The method according to claim 12, which further comprises providing the at least one turbine as a plurality of primary turbines, connecting each of a plurality of shafts to a respective one of the primary turbines, connecting each of a plurality of secondary turbines to a respective one of the shafts, and using the flowing water to turn the plurality of secondary turbines.

14. The vortex hydroturbine according to claim 12, which further comprises using at least one flow guide associated with the at least one turbine for directing the circulating liquid in a circumferential direction of the tank and creating a vortex in the liquid in the tank.

15. The method according to claim 12, which further comprises providing the tank with a frustoconical shape, a bottom and a top having a larger diameter than the bottom, and placing the central turbine on the bottom to facilitate formation of a vortex in the tank.

16. The method according to claim 13, which further comprises supplying the water to drive the at least one turbine from at least one of a river, a stream, a lake, a reservoir, a vehicle or a municipal water supply through a pipe sequentially to each of said secondary turbines.

17. The method according to claim 12, which further comprises feeding the liquid to the tank through an inlet pipe.

18. The method according to claim 12, which further comprises charging a capacitor with the electricity produced by the electric generator.

19. The method according to claim 12, which further comprises using a crossover switch to connect the electric generator to a municipal power line.
